(19) United States
(12) Patent Application Publication
(10) Pub. No.: US 2004/0166298 A1
(43) Pub. Date: Aug. 26, 2004

(54) Plastic masking cover

(76) Inventors: Graham M. Chapman, Niagara-On-The-Lake (CA); Adam K. Lowry, San Francisco, CA (US); Paul C. Keiswetter, Petoskey, MI (US); James K. Craig, Harbor Springs, MI (US)

Correspondence Address: John A. Waters, Waters & Morse, P.C., Ste. 400, 125 Ottawa Ave., N.W., Grand Rapids, MI, 49503, US

(21) Appl. No.: 10/784,857

(22) Filed: Feb. 23, 2004

Related U.S. Application Data
(63) Continuation of application No. 09/508,028, filed on Oct. 30, 2000, now abandoned.
Application No. 09/508,028 is a 371 of international application No. PCT/US98/11721, filed on Jun. 5, 1998.
(60) Provisional application No. 60/048,791, filed on Jun. 6, 1997.

(51) Int. Cl. B05D 3/04; B32B 27/08

(52) U.S. Cl. 428/212; 428/515; 428/523

(57) ABSTRACT

A plastic masking film comprises at least two layers, an outer layer having sufficient surface energy to ensure the adherence of paint, and an inner layer providing cling to a surface. The outer layer comprises a corona-treated thermoplastic material having a surface with a surface energy greater than 50 dynes/cm. at the time of manufacture and which remains at a minimum of 35 dynes/cm. until use. The thermoplastic material of the outer layer comprises one or a combination of members selected from the group consisting of ethylene vinyl acetate, polyvinyl alcohol, polyvinyl acetate, ethylene vinyl alcohol, and high density polyethylene. The inner layer comprises high density polyethylene. Desirably, the film also includes a central core layer formed of one or a combination of polyolefins, preferably low-density polyethylene or linear low-density polyethylene, compatible with the inner and outer layers. A mineral or other particulate filler can be incorporated in the outer layer to improve the adhesion of paint or coatings to the plastic surface.

### CROSS REFERENCE TO RELATED APPLICATION

This is a continuation of co-pending non-provisional U.S. patent application Ser. No. 09/508,028, filed Oct. 30, 2000, which was filed as International Application No. PCT/US 98/11,721 on Jun. 5, 1998, which is based on and claims the benefit of non-provisional Patent Application No. 60/048,791, filed Jun. 6, 1997.

### BACKGROUND OF THE INVENTION

The invention relates to protective masking material used in painting, re-painting, touching-up or detailing metal and other material surfaces in the automotive, aircraft, marine and other industries. The traditional way to protect a surface from stray and unnecessary paint or other coating materials has been to cover the surface required to be protected with a paper (including coated paper), generally dispensed from a roll. At the edges this paper is taped to the surface to be protected with an adhesive tape.

Paper has several disadvantages. First, it has to be coated to make it at least partially impervious to the typical materials used in coating and painting. Second, it is stiff and difficult to maneuver around corners and into position. Further, it is susceptible to humidity and water and thus has problems during wet sanding and accidental exposure to water spraying in repair and body shops. Finally, because paper does not cling to metal or other surfaces, it is difficult to apply. Two hands are necessary to apply it, so one hand is not free for taping.

Simple commodity plastic covering, e.g. polyethylene film (PE), overcomes many of the disadvantages of paper. It is not susceptible to water and is sufficiently flexible to be maneuverable, but it does not have sufficient cling and suffers from a major problem because adhesion of paint is poor. Paint that is sprayed on to the polyethylene surface does not adhere and flakes off after drying, causing problems in the area where the painting is taking place, such as an automotive body shop.

The problem with adhesion to polyethylene is due to the low surface energy (or surface tension) of unmodified and untreated polyethylenes; typically the surface energy of PE is 29-31 dynes/cm. In order for a coating to bond initially to a surface such as PE the substrate needs to have a surface energy at least 10 dynes/cm. greater than the surface tension of the liquid. The surface energy of PE is too low for most solvents.

Several methods have been used to overcome the problem of paint flaking.

One is to use special plastic materials with higher paint adhesion characteristics.

Unfortunately, only a limited number of plastics are satisfactory, and most are quite expensive. Another method is to add a mineral or filler additive to the plastic to roughen the surface. The effect of additives is limited, however, and they can have an adverse effect on film strength in high concentrations. Some additives, such as slip additives, also can migrate to the film surface over time.

In addition to the foregoing, there are several physical and chemical treatments that can be used to increase the surface energy of a film. For improving the adhesion of printing inks, corona discharge is sometimes used. This involves the formation of a cold plasma by electrical discharge in atmospheric conditions. Another technique uses radio frequency or microwave energy under vacuum. An alternative to corona discharge is flame plasma treatment in which plasma is produced by burning a hydrocarbon fuel, which produces ions, free electrons, carbon atoms and oxygenated carbon and hydrocarbon molecules. Ozone treatment, either on its own or in combination with corona treatment, also is used to achieve surface oxidation and an increase in surface energy.

An object of the present invention is to provide an improved masking film that has good paint adhesion characteristics, clings well to the product being painted, and has desirable strength and cost advantages.

### SUMMARY OF THE INVENTION

A masking film in accordance with the present invention comprises at least two and preferably three co-extruded layers, including an inner layer that has enhanced “cling” properties; an outer layer which has desirable paint adhesion characteristics and resists paint peeling; and desirably a middle layer which contributes appropriate strength and tear characteristics to the product. The film also resists ultraviolet degradation.

The inner layer of the present invention is a higher density polyethylene having good cling properties. High density polyethylene (HDPE) at a thickness of about 0.2 to 1.0 mils (about 5 to 25 microns) in a three layer film provides cling and stiffness to the product and resists paint penetration to the covered surface. HDPE also has a higher melting point (which is desirable when paint is cured by baking) and is less abrasive than other polyethylenes on a car surface.

The outer layer is formed from a treated polymer having a high surface energy. Polymers that have been found to work well include one or a combination of polyvinyl alcohol; polyvinyl acetate; ethylene vinyl alcohol copolymers (of ethylene co-monomer ratios of between 27 and 48 percent); ethylene vinyl acetate or “EVA” (with a vinyl content of between 7 and 28 percent); and high density polyethylene (HDPE). EVA is especially preferred. Polyacrylates and polyesters also work but are quite expensive. Even the less expensive materials are more expensive than conventional low density polyethylene. Accordingly, it is preferred that they be used as a thin layer of about 0.2 to 0.3 mils (about 3 to 25 microns) in a three layer co-extruded structure. This is sufficient to achieve the required surface effect but is cost effective. The surface energy of the EVA or other selected polymer is enhanced by applying a surface treatment to the polymer. Specifically, corona discharge on the surface has been used to provide a surface energy of at least 50 dynes/cm. at the time of treatment. Corona-treated polyolefins also will work as an outside layer but they are not as satisfactory as EVA and the other polymers. HDPE is preferred over lower density polyethylenes. A difference in surface energy alone does not appear to explain the superiority of the other polymers.

The film can be formed with just the outer and inner layers. However, the outer and inner surface layers desirably are co-extruded with a central core layer of a more cost effective material that provides the desired combination of tensile strength, elasticity, and tear strength. The use of an inexpensive core layer for strength makes it possible to make the more expensive outer and inner layers thinner. The core layer is a thermoplastic polymer compatible with the outer and inner layers, such as polyethylene or polypropylene, preferably low density polyethylene or a combination of low density polyethylene and linear low density polyethylene. In order to provide a product that can be dispensed satisfactorily in roll form on a typical masking paper dispenser, a combination of good tensile strength and machine direction tear is necessarily combined with a relatively weak cross-directional tear. This can be achieved by using the selected polymers in combination with the processing conditions necessary to provide these characteristics. It has been found that by using at least 70 percent of a fractional melt index low density polyethylene in the center layer, good strength and tear properties can be produced.

While the individual characteristics of the surface layers is a major factor in the cling and paint adhesion characteristics of the product, the process of co-extrusion and the combination of materials extruded also influence the characteristics of the final product. For instance, co-extruding a soft material on a hard material seems to enhance static energy and cling properties. The use of separate extruders for the separate materials also appears to enhance the cling properties of the product.

### BRIEF DESCRIPTION OF THE DRAWINGS

FIG. 1 is a perspective view of a roll or “log” of masking film.

FIG. 2 is a cross-sectional view of the masking film.

### DETAILED DESCRIPTION OF PREFERRED EMBODIMENT

Referring to the drawings, plastic masking film 10 comprises an outer layer 12, an inner layer 14 and desirably a core or middle layer 16. The inner layer is designed to be applied to the surface 18 of an automobile body or other product being painted. Film 10 is formed in a conventional manner by co-extrusion.

Inner layer 14 comprises a higher density polyethylene having good cling properties. High density polyethylene (HDPE) having a thickness of about 0.2 to 1.0 mils (about 5 to 25 microns) with a three layer film is satisfactory to provide the necessary surface characteristics and stiffness to the product, while maintaining cost effectiveness by the use of a thin layer.

Outer layer 12 provides paint adherence to hold the paint on coatings during spray, curing, and drying without permitting the paint to flake. The outer layer preferably is EVA having a thickness of about 0.2 to 0.3 mils (about 5-8 microns) in a three layer film. The EVA is treated with a corona discharge treatment in order to enhance the surface energy or surface tension of the outer layer. The outer layer as constructed has a surface energy as high as 50 dynes/cm or higher at the time of manufacture, and the surface energy remains at a minimum of 35 dynes per centimeter until use.

The core layer of the structure comprises polyethylene or other polyolefin to give strength to the film.

A desired core is a combination of low density polyethylene (LDPE) and linear low density polyethylene (LLDPE), including some post-consumer recycle material, having a thickness of about 0.2 to 2.0 mils (about 5 to 50 microns). The LDPE enhances the tearability of the film from conventional masking paper dispensers. The use of a filler material, such as calcium carbonate, also enhances the tearability of the film.

Overall, the plastic film is extruded to a total thickness of about 0.5 to 3.0 mils, (about 12 to 75 microns) with a thickness of about 1.5 mils (about 50 microns) being desirable.

The co-extruded film of the present invention provides a combination of qualities necessary for good masking material. The film is impervious to the constituents of paints and coatings. It has good handleability, which is provided by a combination of polymers which give it the necessary strength, elasticity and tear characteristics. The outer layer resists paint flaking while the inner layer enhances the cling of the film to the product being painted. Thus, the film can simply be laid against the side of the product and it will remain in place for trimming and use. The film is thin, easy to handle, and can easily be applied and removed.

Furthermore, the film oft he present invention has sufficient UV resistance that the film resists adverse effects such as “bloom” on the metallic surface in contact with the film when exposed to ultraviolet radiation.

Another feature of the present invention is the incorporation of a color 24 or printing 26 on at least one side of the material in order to indicate which side of the material is the sticky side and which side is the paint adhesion side. This minimizes the risk of misapplication of the film with the wrong side against the surface to be painted.

Another feature of the present invention is that the film is packaged in logs or rolls that are compatible with the form in which masking paper is presently dispensed.

Masking paper used in auto body shops typically is packaged in long logs or rolls and mounted on roll dispensers. The paper is torn off the rolls in sheets of any desired length. Many plastic masking materials presently on the market are sold in sheet form of separate sheets. The present invention permits the plastic masking material to mount on existing paper dispensers and be dispensed in the same manner as the masking paper that body shop operators are already familiar with.

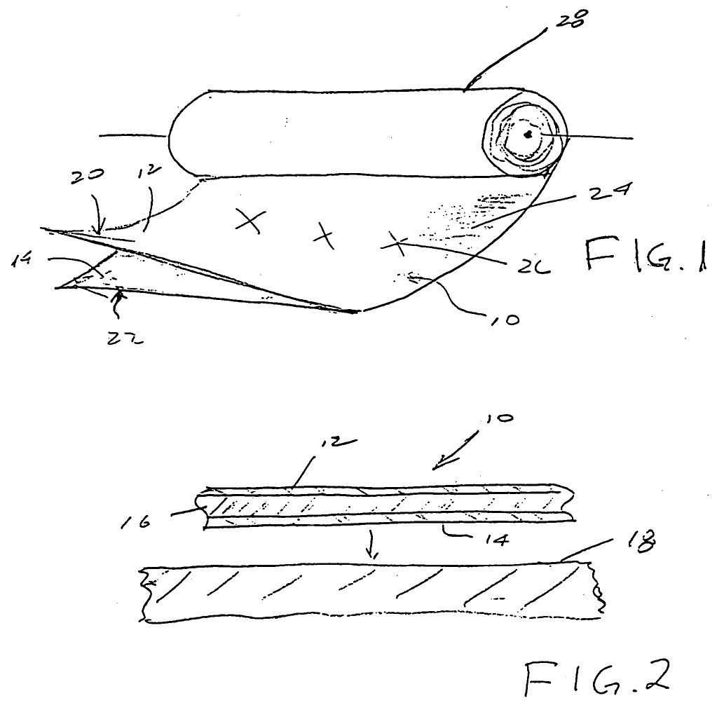

The masking film of the present invention desirably is formed in rolls 28 that are 18 inches wide and approximately 400 feet in length. The film can be folded over once or more on the rolls as shown in FIG. 1 to form folded sheets 20 and 22 in order to provide a wider sheet of material. Preferably, the outer layer 12 is on the exterior surface of the folded material. Alternatively, the rolls can be 36 inches wide (or other widths) and the film can be folded over more than one time to form multiple folded layers. For a full body cover, the unfolded film width can be as much as eight to twelve feet or any width desired. A more narrow width is used for film having a “critical edge”, which is an edge that is designed to be adjacent a surface being painted. The cling characteristics of the sheeting are such that the film clings to the surface of the painted product but does not adhere to itself in a roll with such tenacity that the film cannot be separated. The material, particularly the central core, is fabricated so that the film has good strength in one direction but tears more easily in a transverse direction so the film can more easily be torn off the roll.

It should be understood that the foregoing is merely illustrative of the preferred practice of the present invention and that various modifications in the details of the embodiments disclosed herein may be made without departing from the spirit and scope of the present invention.

1. A plastic masking film for protecting a protected surface from paint directed at the protected surface, the film being formed in a sheet large enough to cover at least a significant portion of the protected surface, the film comprising at least two co-extruded layers, an outer layer and an inner layer, the outer layer having a surface energy of at least about 50 dynes/cm, so as to ensure the adherence of paint to the film and restrain the paint from dripping or flaking, the inner layer comprising a resin with cling properties that cause the film to adhere to the protected surface without the use of an adhesive.

2. A film according to claim 1 in which the outer layer comprises a corona-treated thermoplastic material that retains its surface energy at a minimum of 35 dynes/cm. until use.

3. A film according to claim 2 in which the thermoplastic material of the outer layer comprises one or a combination of members selected from the group consisting of ethylene vinyl acetate, polyvinyl alcohol, polyvinyl acetate, ethylene vinyl alcohol, and high density polyethylene.

4. A film according to claim 1 in which the inner layer comprises high density polyethylene.

5. A film according to claim 1 and further comprising a central core layer formed of one or a combination of polyolefins compatible with the inner and outer layers.

6. A film according to claim 2 in which a mineral or other particulate filler is incorporated in the outer layer to improve the adhesion of paint or coatings to the plastic surface.

7. A film according to claim 1 in which at least one of the layers is colored or marked to visually distinguish between the inner and outer layers.

8. A film according to claim 5 wherein the core layer comprises one or a combination of members selected from the group consisting of low density polyethylene and linear low density polyethylene.

9. A plastic masking film comprising at least three co-extruded thermoplastic layers, an inner layer adapted to contact a product being painted, an outer layer on an opposite exterior surface of the film, and a central core layer between the inner and outer layers, the inner layer comprising high density polyethylene in a thickness of about 0.2 to 1.0 mils (about 5 to 25 microns), the central core layer comprising one or a combination of members formed from the group consisting of low density polyethylene and linear low density polyethylene, the thickness of the inner layer being about 0.2 to 2.0 mils (about 5 to 50 microns), the outer layer comprising a corona-treated material selected from the group consisting of one or a combination of members selected from the group consisting of ethylene vinyl acetate, polyvinyl alcohol, polyvinyl acetate, ethylene vinyl alcohol, and high density polyethylene the outer layer being about 0.2 to 0.3 (about 5 to 8 microns) mils thick.

10. A plastic masking cover for covering a protected surface of a vehicle or other protected surface while other parts of the surface are painted, the plastic masking cover comprising a sheet of plastic film at least about eighteen inches wide, the film having at least two layers and being formed by co-extrusion, the film having an inner layer that contacts the protected surface and an outer layer that faces away from the protected surface and receives paint directed toward the protected surface, the inner layer comprising a material having no adhesive applied thereto but instead having sufficient inherent cling characteristics to cause the film to cling to and remain in a covering position on the protected surface without the use of an adhesive, the cling characteristics of the inner layer being low enough that inner surfaces of the material that contact each other do not cling to each other so aggressively that they can not be separated, the inner layer comprising a polyethylene having a density greater than low density polyethylene, the film having an outer layer comprising one or a combination of members selected from the group consisting of ethylene vinyl acetate, polyvinyl alcohol, polyvinyl acetate, ethylene vinyl alcohol, and high density polyethylene, the outer layer further having an outer surface that is corona treated to an initial level of at least 50 dynes/cm, the outer layer having a sufficient surface energy to induce adhesion of paint sprayed on the material so as to impede paint dripping and paint flaking from the outer surface.

11. A plastic masking cover according to claim 10 wherein the inner layer comprises high density polyethylene.

12. A plastic masking cover according to claim 10 wherein the outer layer comprises high density polyethylene.

13. A plastic masking cover according to claim 12 wherein the outer layer includes ethylene vinyl acetate.

14. A plastic masking cover according to claim 10 and further including a middle layer comprising a polyolefin material.

15. A plastic masking cover according to claim 14 wherein the middle layer comprises one or a combination of low density polyethylene and linear low density polyethylene.

16. A plastic masking cover according to claim 14 wherein the middle layer comprises post-consumer recycled material.

17. A plastic masking cover according to claim 10 wherein the film is packaged in elongated rolls that are dismissible from roll dispensers.

18. A plastic masking cover according to claim 10 wherein the film is dispensable from the roll by crosswise tearing or of a portion from the roll, the film being formed so as to have enhanced tensile strength in a longitudinal direction, but having relatively weak cross-directional tear characteristics that facilitate tearing covers from the roll.
